(19) United States
(12) Patent Application Publication
(10) Pub. No.: US 2014/0329136 A1
(43) Pub. Date: Nov. 6, 2014

(54) BATTERY WIRING MODULE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Yuko Kinoshita, Yokkaichi-shi (JP); Hiroomi Hiramitsu, Yokkaichi-shi (JP); Katsunori Hamana, Yokkaichi-shi (JP); Tomofumi Tsuji, Yokkaichi-shi (JP); Mitsuhiro Akasaka, Yokkaichi-shi (JP); Tetsuya Nakagawa, Yokkaichi-shi (JP); Yoshinao Kobayashi, Yokkaichi-shi (JP); Masaru Shitamichi, Yokkaichi-shi (JP); Daiki Hirano, Utsunomiya-shi (JP)

(21) Appl. No.: 14/356,972

(22) PCT Filed: Nov. 1, 2012
(86) PCT No.: PCT/JP2012/078295

§ 371 Date: May 8, 2014

(30) Foreign Application Priority Data
Nov. 11, 2011 (JP) 2011-247493

(51) Int. Cl. H01M 2/20

(52) U.S. Cl. CPC H01M 2/206
USPC 429/158

(57) ABSTRACT

A battery wiring module, which is attached to a battery group formed by juxtaposing a plurality of batteries each having positive and negative electrode terminals, includes; a plurality of bus bars connected to the electrode terminals; and a resin protector made of an insulating resin and having a holding portion holding the bus bars. The holding portion of the resin protector is provided with a bus bar insertion portion adapted to insert the bus bars in a direction in which the plurality of batteries is juxtaposed.

### TECHNICAL FIELD

This invention relates to a battery wiring module.

### BACKGROUND ART

In a battery module for use in electric vehicles and hybrid vehicles, a plurality of batteries each having electrode terminals at its cathode and anode is arranged in juxtaposition. In such a battery module, the batteries are electrically connected with one another by connecting the electrode terminals of the cathodes (positive electrode terminals) with the electrode terminals of the anodes (negative electrode terminals) with use of bus bars.

In order to electrically connect the batteries, a battery wiring module as disclosed in, for instance, Patent Document 1, is used.

### RELATED ART DOCUMENT

### Patent Document

[Patent Document 1] Japanese Unexamined Patent Application Publication No. 2011-8955

### DISCLOSURE OF THE INVENTION

### Problem to be Solved by the Invention

According to the battery wiring module disclosed in Patent Document 1 mentioned above, a plurality of resin connector units each having a bus bar holding portion is coupled together. After the bus bar is housed in the bus bar holding portion of each connector unit from the above, the connector units are placed onto terminal forming surfaces of the batteries (i.e., the electrode-terminals forming surfaces), and the bus bars are connected with the electrode terminals.

However, when the bus bar holding portion is small in the battery wiring module as described above, the bus bar is difficult to be inserted from the above. When there is a great size difference between the bus bar holding portion and the bus bar, the bus bar may be positioned at a position displaced from a proper position.

Further, when the battery wiring module configured such that the bus bar is inserted from the above as described above is attached to the battery group, the connector unit may collide with the electrode-terminals forming surfaces of the batteries included in the battery group or with the electrode terminals, and the bus bar housed in the bus bar holding portion of the connector unit may be pressed upward to be disengaged from the connector unit.

When the bus bar is positioned at a displaced position or disengaged therefrom, the bus bar needs to be inserted again to be positioned at the proper position, and thus the operations may not be efficient.

Completed with the background described above, the invention serves to provide a battery wiring module attachable to a battery group with enhanced efficiency.

### Means for Solving the Problem

As a solution to the problems described above, an aspect of the invention provides a battery wiring module attached to a battery group formed by juxtaposing a plurality of batteries each having positive and negative electrode terminals, and the battery wiring module includes: a plurality of connectors connected to the electrode terminals; and a resin protector made of an insulating resin and having a holding portion that holds the connectors. In the battery wiring module, the holding portion of the resin protector is provided with a connector insertion portion through which the connectors are inserted in a direction in which the plurality of batteries is juxtaposed.

According to the aspect of the invention, the resin protector is provided with the connector insertion portion inserting the connectors in the direction in which the batteries are juxtaposed. In other words, the connectors are inserted in the direction in which the batteries are juxtaposed. Therefore, even if the terminal forming surfaces or the electrode terminals of the batteries collide with the resin protector, the connectors are not easily pushed upward. Thus, the disengagement of the connectors at the time of attaching the battery wiring module to the battery group is prevented. As a result, the aspect of the invention provides the battery wiring module efficiently attachable to the battery group.

The aspect of the invention may include the following configuration.

The resin protector may include a plurality of holder units each having the holding portion and the connector insertion portion.

With this configuration, by preparing the holder units in which the connectors are held by the holding portion after having been inserted through the connector insertion portion in the juxtaposition direction of the batteries, such that the number of the holder units corresponds to the number of the batteries, the battery wiring module is attachable to a variety of battery groups.

A front end of the holding portion of the holder unit (i.e., an end located frontward in a direction in which the connectors are inserted) may be provided with an insulating wall that keeps the connector insulated from a connector of a neighboring holder unit.

The connectors held by the holder unit may be held with their portions exposed through the connector insertion portion. Thus, there is a concern over the contact between the connectors held by the neighboring holder units. With the configuration described above, the insulating wall provided to the front end of the holding portion of the holder unit (i.e., the end located frontward in a direction in which the connectors are inserted) keeps the connectors held by the neighboring holder units insulated from each other.

The holding portion may be provided with a locking portion that locks the connectors to the holding portion.

With this configuration, the connectors inserted through the connector insertion portion are locked to the holding portion. Thus, the disengagement of the connectors is more reliably prevented.

The holding portion may be provided with a locking portion that locks the connectors, and the connectors may be provided with locked portions to be locked by the locking portion provided to the holding portion.

With this configuration, the locked portions of the connectors are locked by the locking portion of the holding portion. Thus, the disengagement of the connectors from the holding portion is more reliably prevented.

The holding portion may be provided with a guide that guides the connectors from the connector insertion portion frontward in the direction in which the connectors are inserted.

With this configuration, the connectors are inserted smoothly, and the operability is enhanced.

An edge of the holding portion disposed to extend in the direction in which the batteries are juxtaposed may be provided with a holding wall that holds the connectors without exposing the connectors from the holding portion.

With this configuration, the connectors are not exposed from the edge of the holding portion disposed to extend in the direction in which the batteries are juxtaposed. Therefore, the connectors are kept insulated from the conductive members disposed in the neighborhood of the holding portion.

### Advantageous Effect of the Invention

According to the aspect of the invention, the battery module is more efficiently attached to the battery group.

### BRIEF DESCRIPTION OF THE DRAWINGS

FIG. 1 is a plan view depicting a battery module to which a battery wiring module according to a first embodiment is attached.

FIG. 2 is a front view depicting the battery module.

FIG. 3 is a plan view depicting the battery module to which the battery wiring module is attached with a first lid open.

FIG. 4 is a plan view depicting a holder unit.

FIG. 5 is a magnified perspective view primarily depicting an elastic engaging portion (a locking portion) of the holder unit.

FIG. 6 is a perspective view depicting bus bars (connectors) and voltage detecting terminals being disposed onto the holder unit.

FIG. 7 is a lateral view depicting the holder unit with the first lid and a second lid open.

FIG. 8 is a front view depicting the holder unit with the first lid and the second lid open.

### BEST MODE FOR CARRYING OUT THE INVENTION

### First Embodiment

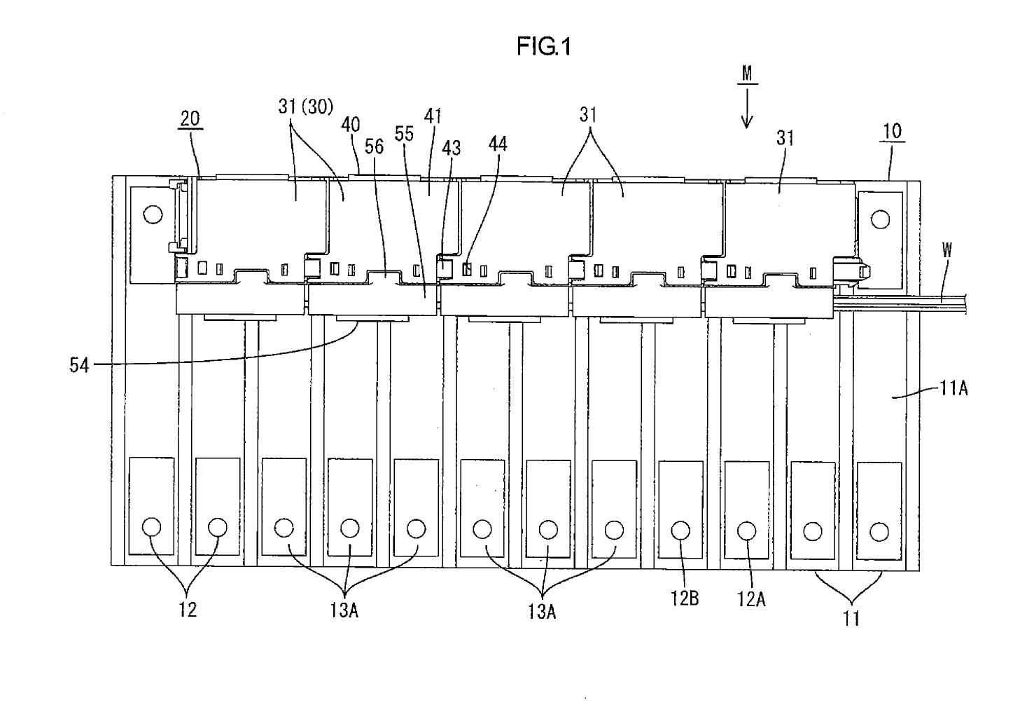

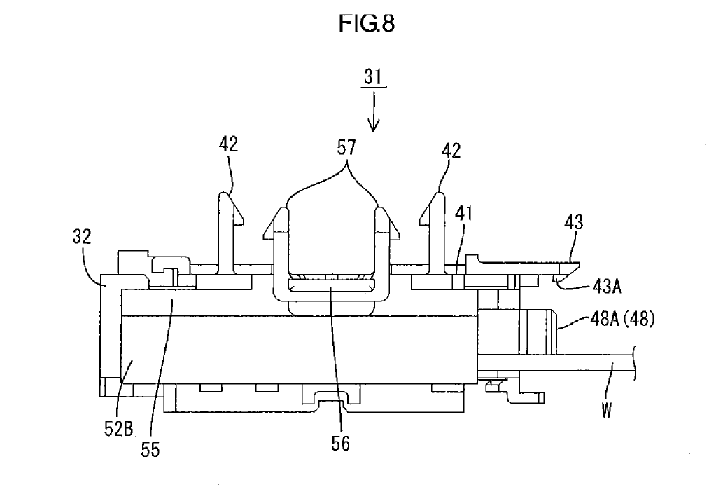

A first embodiment of the invention will be described with reference to FIGS. 1 to 8. A battery wiring module 20 according to this embodiment is attached to a battery group 10 provided by juxtaposing a plurality of batteries 11 (in this embodiment, twelve batteries) each having electrode terminals 12 at its cathode and anode. In the following description, the electrode terminal 12 at the cathode will be referred to as a positive electrode terminal 12A while the electrode terminal 12 at the anode will be referred to as a negative electrode terminal 12B. The positive electrode terminal 12A and the negative electrode terminal 12B are collectively referred to as the electrode terminals 12.

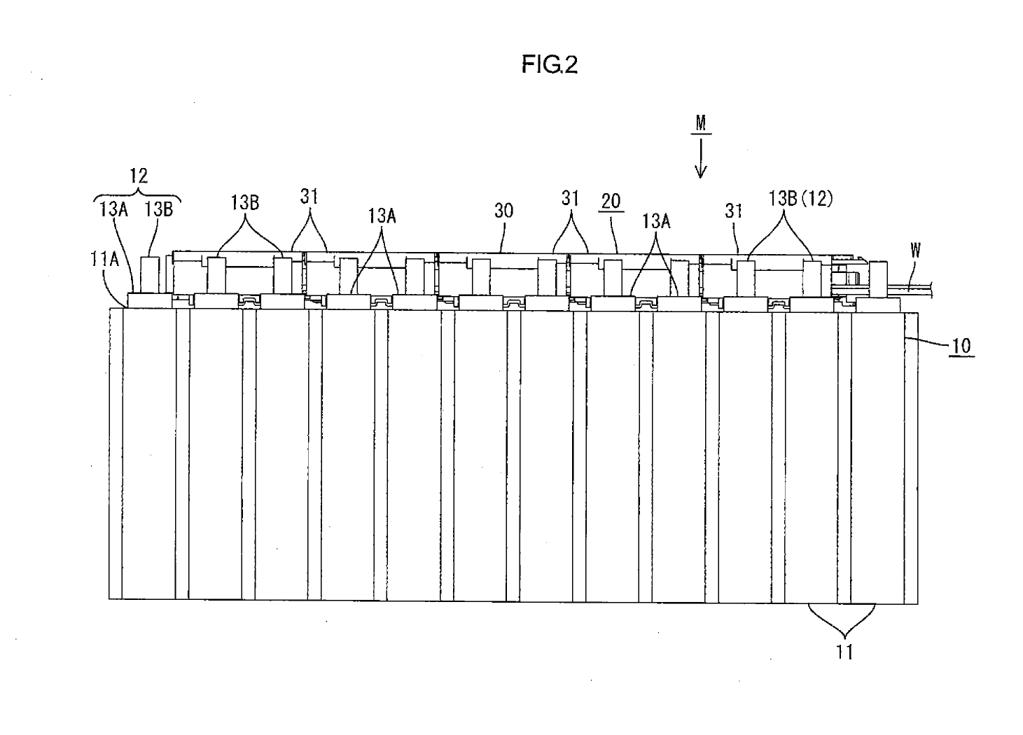

A battery module M, which is provided by attaching the battery wiring module 20 according to this embodiment to the battery group 10, is used as the driving source of vehicles (not depicted) such as electric vehicles and hybrid vehicles. The plurality of batteries 11 included in the battery group 10 is connected with one another in series by electrically connecting the positive electrode terminal 12A of one battery 11 with the negative electrode terminal 12B of another battery 11 with use of the battery wiring module 20. In the following description, the upper side and the lower side shall refer to the upper side and the lower side in FIGS. 2, 7 and 8 respectively.

(Battery 11)

Each battery 11 is flat and rectangular. As depicted in FIGS. 1 and 2, the upper surface 11A of the battery 11 is provided with the positive electrode terminal 12A and the negative electrode terminal 12B. The electrode terminals 12 each include: a base 13A made of a metal plate; and an electrode post 13B protruding upward from the base 13A to form a round bar shape. The surface of the electrode post 13B is provided with a screw thread (not depicted). The plural batteries 11 are arranged such that the electrode terminals 12 of the neighboring batteries 11 respectively, exhibit different polarities (i.e., the positive electrode terminal 12A and the negative electrode terminal 12B are alternately arranged.). The electrode post 13B is inserted into a through hole 23 of a bus bar 21 (an example of a connector), and fixed to the bus bar 21 by screwing (not depicted). In addition, the plural batteries 11 are fixed together by a holder (not depicted) such that the batteries 11 form the battery group 10.

(Battery Wiring Module 20)

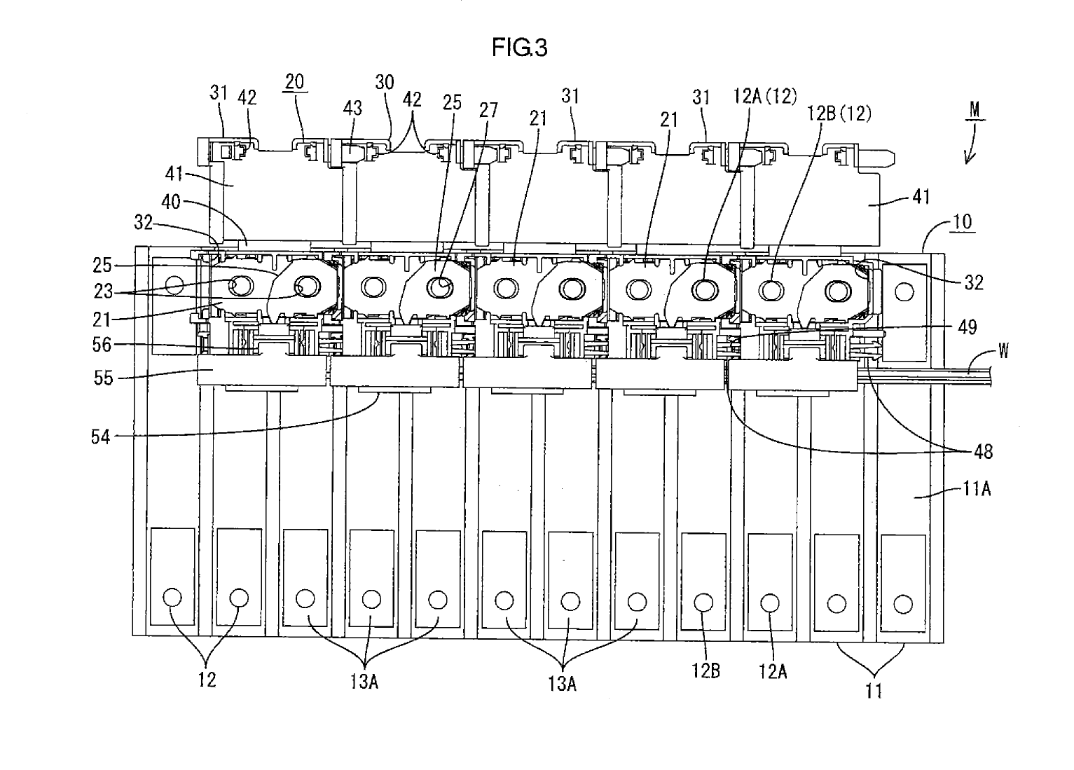

The battery wiring module 20 is attached to two lines of the electrode terminals 12 that extend in the right and left direction of the battery group 10 as depicted in FIG. 1. In FIGS. 1 to 3, the battery wiring module 20 is attached only to the line of the electrode terminals 12 located on the side apart from the reader in FIGS. 1 and 3.

The battery wiring module 20 includes: a plurality of bus bars 21 each having a pair of through holes 23 (connected portion), into which the electrode posts 13B of the positive electrode terminal 12A and the negative electrode terminal 12B of the batteries 11 are inserted for connection; a plurality of voltage detecting terminals 25 connected to the bus bars 21 and adapted to detect the voltages of the batteries 11; and a plurality of resin protectors 30 each having a holding portion 32 that holds the bus bar 21 and made of a synthetic resin.

(Bus Bar 21)

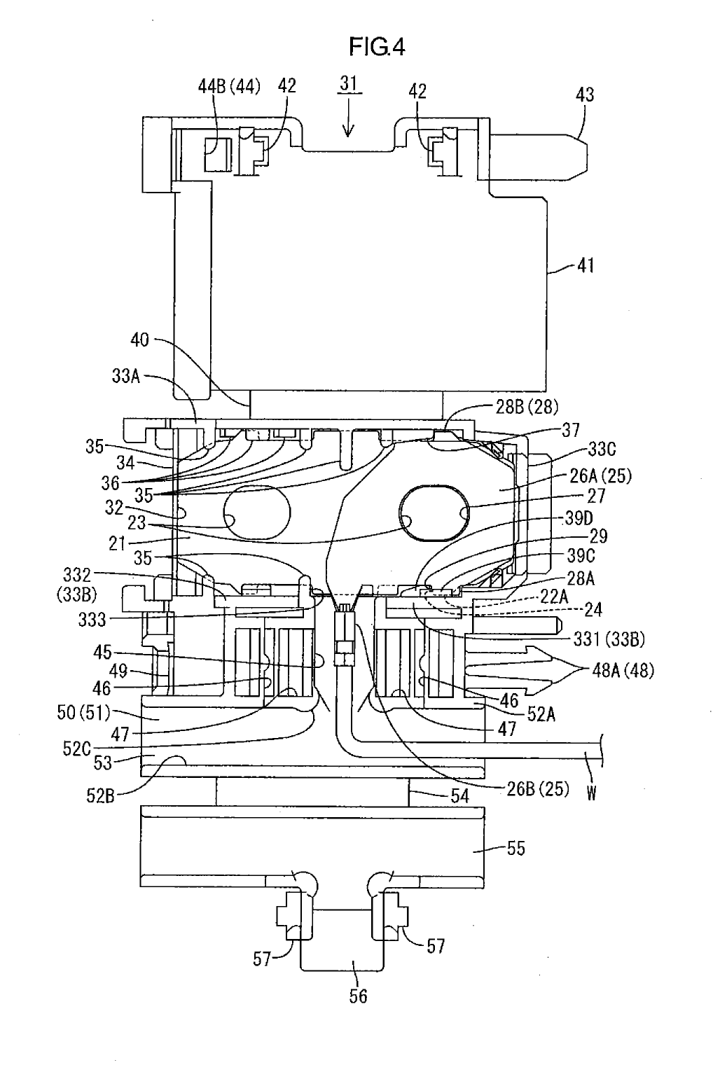

The bus bar 21 is formed through press working by shaping into a predetermined shape a plate material made of copper, copper alloy, stainless steel, aluminum or the like. The front surface of the bus bar 21 is plated with a metal such as tin or nickel. The lengthwise dimension of the bus bar 21 (i.e., the dimension in the right and left direction in FIGS. 3 and 4) is determined in accordance with the dimension between the electrode terminals 12A and 12B of the neighboring batteries 11.

The bus bar 21 is provided with the pair of through holes 23 with a predetermined interval interposed therebetween. The electrode posts 13B of the electrode terminals 12 of the battery 11 are respectively inserted into the paired through holes 23. The through holes 23 in this embodiment are elongated in the direction in which the batteries 11 are juxtaposed (i.e., in the right and left direction in FIG. 3). In this embodiment, the elongated through holes 23 absorb the irregularities of the pitches between the neighboring electrode terminals 12A and 12B, which are caused due to a manufacturing tolerance and an assembling tolerance of the batteries 11.

Further, the bus bar 21 is shaped such that the four corners of a rectangular flat plate are rounded, and with this configuration, the bus bar 21 is smoothly inserted into the holding portion 32 of the resin protector 30.

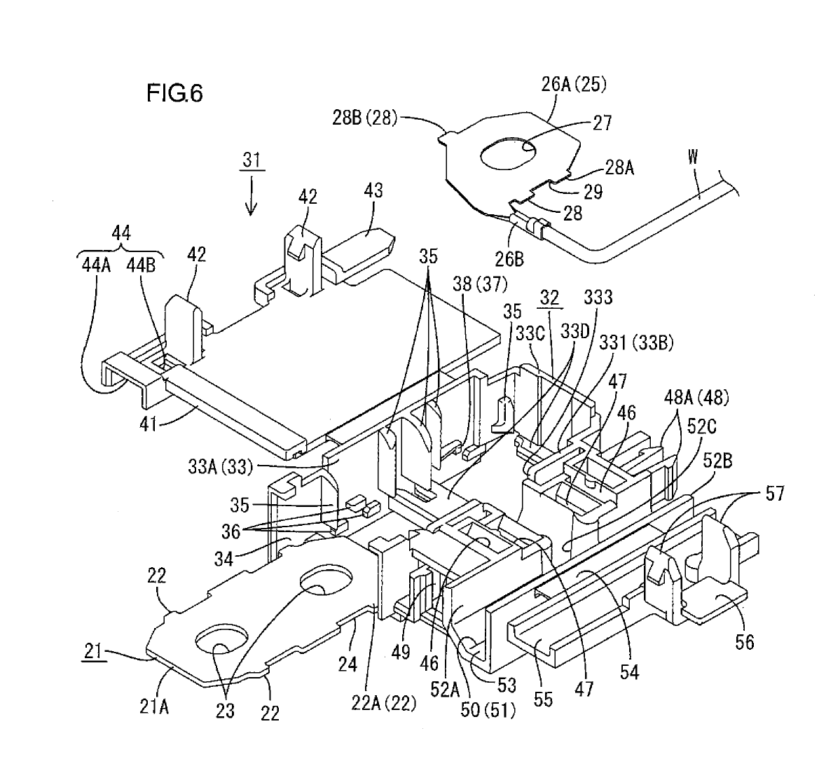

The bus bar 21 further includes expanded portions 22 expanded in the widthwise direction (shorter side direction) of the bus bar 21 and exhibiting a trapezoid shape in a top view. As depicted in FIG. 6, the expanded portions 22 are provided on both ends of the bus bar 21, and expand from the paired lengthwise end surfaces of the bus bar 21. The paired lengthwise end surfaces of the bus bar 21 are also provided with recesses 24 that neighbor the trapezoid expanded portions 22. In respect of the two expanded portions 22 provided to the bus bar 21 and located closer to the reader in FIG. 4, the right expanded portion 22A is locked by a bus bar locking nail 39D of the holding portion 32 accepted in the neighboring recess 24 (an example of an locked portion).

(Voltage Detecting Terminal 25)

The voltage detecting terminal 25, which is to be layered on the bus bar 21, includes a flat plate body 26A, and the barrel 26B continued from the body 26A. The detecting wire W is crimped to the barrel 26B. The center of the body 26A is opened to have an insertion hole 27. When the insertion hole 27 is layered on either one of the paired through holes 23 of the bus bar 21, the electrode post 13B of the electrode terminal 12, which has been inserted into the through hole 23 of the bus bar 21, is further inserted into the insertion hole 27. The insertion hole 27 is slightly greater than the through hole 23 of the bus bar 21.

In the voltage detecting terminal 25, the end edge where the barrel 26B is provided, and an end edge opposed to the aforementioned end edge are each provided with protruding pieces 28 extending outward therefrom. In respect of the two protruding pieces 28 provided to the end edge where the barrel 26B is provided, the protruding piece 28A located on the right side in FIG. 4 (first protruding piece 28A) is locked by the terminal locking nail 39C of the holding portion 32. With this configuration, the voltage detecting terminal 25 is restricted from moving upward. Between the two protruding pieces 28 provided to the end edge of the barrel 26B, a recess 29 is provided by a cutout. The recess 29 of the voltage detecting terminal 25 is disposed to be partially layered upon the recess 24 of the corresponding bus bar 21, so that the bus bar locking nail 39D is accepted.

The protruding piece 28 provided to the end edge opposed to the end edge where the barrel 26B is provided (second protruding piece 28B) is locked by the terminal locking piece 37 of the holding portion 32. With this configuration, the voltage detecting terminal 25 is restricted from moving in the up and down direction.

The voltage detecting terminal 25 is formed through press working by shaping into a predetermined shape a plate material made of copper, copper alloy, stainless steel, aluminum or the like. The surface of the voltage detecting terminal 25 may be plated with a metal such as tin or nickel.

The detecting wire W connected to the voltage detecting terminal 25 is housed in the wire housing 50 of the later-described resin protector 30, and connected to the monitoring ECU (not depicted) located on the right side in FIG. 1. The monitoring ECU, which has a known configuration installed with a micro computer, devices and the like, detects the voltage, the current, the temperature and the like of the batteries 11, and monitors to control the batteries 11.

(Resin Protector 30)

As depicted in FIG. 1, the resin protector 30 includes a plurality of holder units 31 (five holder units 31 in this example) coupled together in the right and left direction. The plural holder units 31 are juxtaposed in the direction in which the batteries 11 are juxtaposed.

(Holder Unit 31)

The neighboring holder units 31 are mutually coupled together. The coupling structure of the holder units 31 will be described later in detail.

The holder unit 31 includes: the holding portion 32 housing and holding the bus bar 21 and the voltage detecting terminal 25; a guiding groove 45 that guides the detecting wire W connected to the voltage detecting terminal 25; the wire housing 50 that houses the detecting wire W of the voltage detecting terminal 25 taken out from the guiding groove 45; a first lid 41 that covers the holding portion 32; and a second lid 55 that covers the wire housing 50. These members are integrally formed. In the following description, each member will be described.

(Holding Portion 32)

The holding portion 32, which is open upward, includes: an encompassing wall 33 (33A, 33B and 33C) closing three lateral sides other than the left side in FIG. 4 such that the bus bar 21 is housed; and a bottom wall 33D upon which the bus bar 21 is mounted.

As depicted in FIG. 6, the bottom wall 33D is partially provided to each of the substantially central portion, left end portion and right end portion of the holding portion 32 (as depicted). The bus bar 21 is partially mounted on the bottom wall 33D, and the bottom wall 33D is configured to not interrupt the electric connection between the bus bar 21 and the electrode terminal 12.

As depicted in FIG. 2, the encompassing wall 33 is sized to be higher than the upper end of the electrode terminal 12 when the battery wiring module 20 is attached to the battery group 10. This arrangement suppresses tools or the like from contacting the positive terminal 12A and the negative terminal 12B, thereby suppressing the short circuit between the positive terminal 12A and the negative terminal 12B via the tools or the like.

The encompassing wall 33 includes: a rear wall 33A extending along a first lengthwise lateral edge of the bus bar 21, which is positioned on the side apart from the reader in FIG. 4; a front wall 33B extending along a second lengthwise lateral edge of the bus bar 21, which is positioned on the side closer to the reader in FIG. 4; and a right wall 33C extending along a right shorter lateral edge of the bus bar 21, which is positioned on the right side in FIG. 4. At substantially the lengthwise center of the front wall 33B, an opening 333 is opened to penetrate through the guiding groove 45, and the opening 333 divides the front wall 33B into two portions. In respect of the two divisional portions of the front wall 33B divided by the opening 333, the first one located on the right side in FIG. 4 will be referred to as a right front wall 331 while the second one located on the left side in FIG. 4 will be referred to as a left front wall 332.

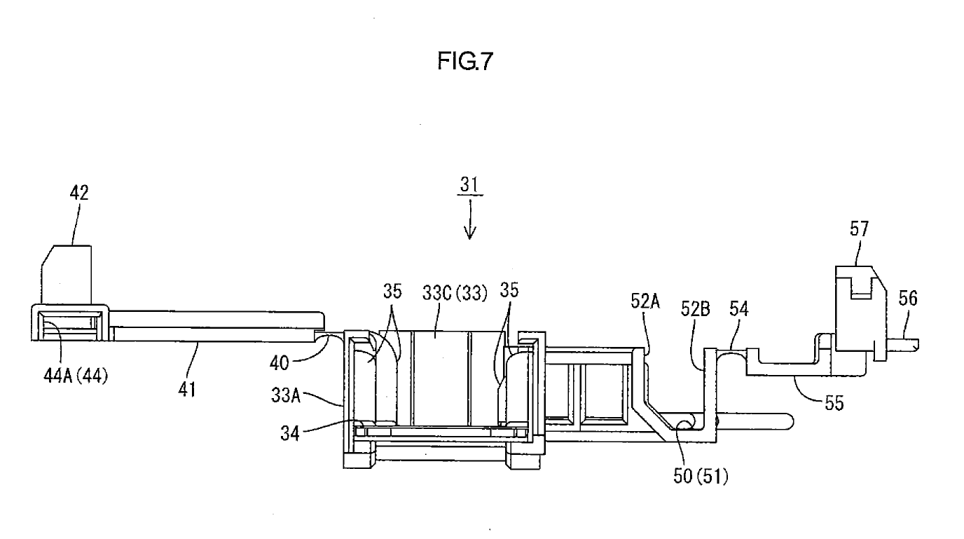

In this embodiment, the holding portion 32 has no encompassing wall 33 in a direction facing a left shorter lateral edge of the bus bar 21, which is positioned on the left side in FIG. 4 (left lateral edge 21A), thereby providing an open end 34 (see, FIGS. 6 and 7). Through the open end 34, the bus bar 21 is inserted in the direction in which the batteries 11 are juxtaposed (the right and left direction in FIG. 4), and the open end 34 serves as a bus bar insertion portion 34 (an example of a connector insertion portion).

The right wall 33C of the encompassing wall 33 is disposed at the end of the bus bar 21 located frontward in the insertion direction of the bus bar 21, and serves as an insulating wall 33C that keeps the bus bar 21 insulated from the bus bar 21 held by the neighboring holder unit 31.

As depicted in FIGS. 6 and 7, the inner walls of the front wall 33B and the rear wall 33A are each provided with a plurality of locking portions 35 protruding inward and locking the inserted bus bar 21 by restricting the movement of the bus bar 21 in the up and down direction.

The region of the rear wall 33A closer to the open end 34 relative to the center (the left side in FIG. 4) is provided with a guide 36. As depicted in FIGS. 4 and 6, the guide 36 protrudes from the region and guides the bus bar 21 inserted into the holding portion 32 through the open end 34 (the bus bar insertion portion) of the holding portion 32, to the front side in the insertion direction (i.e., toward the insulating wall 33C).

The region of the rear wall 33A closer to the right wall 33C relative to the center (the right side in FIG. 4) is provided with a terminal locking piece 37. The terminal locking piece 37 protrudes from the region and restricts the voltage detecting terminal 25 from moving upward and from moving frontward in the insertion direction of the bus bar 21 (i.e., toward the right side in the depiction). The terminal locking piece 37 extends in the insertion direction of the bus bar 21, and the bus bar 21 and the voltage detecting terminal 25 are disposed under the terminal locking piece 37. The front end of the terminal locking piece 37 (i.e., the end located on the front side in the insertion direction of the bus bar 21) is provided with a locking protrusion 38, and the locking protrusion 38 locks a second protruding piece 28B of the voltage detecting terminal 25 (see FIG. 4).

In this embodiment, as depicted in FIG. 6, the rear wall 33A of the encompassing wall 33 has no portion through which the bus bar 21 is exposed to the outside of the holding portion 32 (e.g., slit). Accordingly, the rear wall 33A extending in the direction in which the batteries are juxtaposed holds the bus bar 21 without exposing the bus bar 21 from the holding portion 32. Thus, the rear wall 33A prevents the short circuit from being caused by a contact of the tools or metal members disposed in the neighborhood with the bus bar 21.

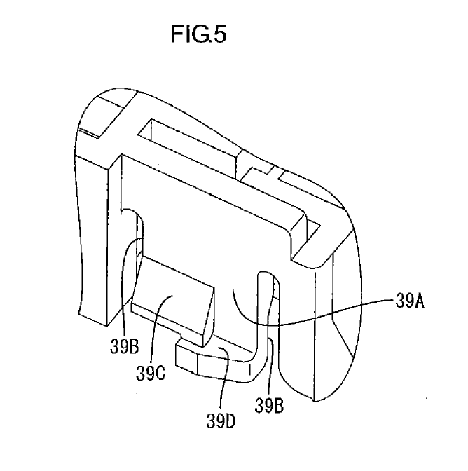

As depicted in FIG. 5, the right front wall 331 of the encompassing wall 33 is provided with two slits 39B extending upward from the lower end, and an elastic engaging piece 39A is formed between the two slits 39B. The elastic engaging piece 39A includes: a terminal locking nail 39C that locks the voltage detecting terminal 25; and a bus bar locking nail 39D (an example of a locking portion) that locks the bus bar 21. The terminal locking nail 39C and the bus bar locking nail 39D are juxtaposed in the up and down direction. The bus bar locking nail 39D is displaced from the terminal locking nail 39C rearward in the insertion direction of the bus bar 21 (i.e., toward the right side in FIG. 5), and the terminal locking nail 39C and bus bar locking nail 39D are partially layered on each other.

The terminal locking nail 39C is elastically deformed outward of the encompassing wall 33 when the first protruding piece 28A of the voltage detecting terminal 25 inserted from the above abuts on the terminal locking nail 39C. However, when the voltage detecting terminal 25 is positioned at a position lower than the lower end of the terminal locking nail 39C, the terminal locking nail 39C elastically returns to the original position, thereby restricting the voltage detecting terminal 25 from moving upward.

The bus bar locking nail 39D is elastically deformed outward of the encompassing wall 33 when the expanded portion 22A of the bus bar 21 inserted through the open end 34 passes through. However, when the recess 24 of the bus bar 21 is positioned, the bus bar locking nail 39D is accepted into the recess 24 and elastically returns to the original position. With this operation, the bus bar 21 is locked by the bus bar locking nail 39D. In this embodiment, the recess 29 of the voltage detecting terminal 25, which is located right above the recess 24 of the bus bar 21, is also locked by the bus bar locking nail 39D.

(First Lid 41)

As depicted in FIGS. 1, 3, 4 and 6, the holding portion 32 is provided integrally with the first lid 41 via a hinge 40 continued from the upper end of the rear wall 33A of the encompassing wall 33. The first lid 41 is rotated around the hinge 40. When the first lid 41 is closed, the first lid covers the entire holding portion 32 as well as a part of the guiding groove 45 (see FIG. 1).

As depicted in FIGS. 4 and 6, a pair of first locking pieces 42 protrudes from the surface of the first lid 41 that faces downward when the first lid 41 is closed. The first locking pieces 42 are locked by first locking grooves 46 formed at positions adjacent to second locking grooves 47 (described later) provided to both widthwise sides of the guiding groove 45. The first lid 41 includes a lid joint engaging piece 43 and a lid joint engaged portion 44 that joint the first lid 41 with the respective first lids 41 of the neighboring holder units 31. The lid joint engaging piece 43 and the lid joint engaged portion 44 are positioned at positions adjacent to the paired first locking pieces 42, and any further details thereof will be described later.

(Guiding Groove 45)

In the guiding groove 45, the barrel 26B of the voltage detecting terminal 25 taken out from the holding portion 32 and the detecting wire W crimped to the barrel 26B are disposed. The guiding groove 45 is a groove member in communication with the holding portion 32 and the wire housing 50. The guiding groove 45 is recessed, and extends substantially perpendicularly to the direction in which the batteries 11 are juxtaposed. More specifically, the guiding groove 45 penetrates through an opening 52C of a rear groove wall 52A (details of which will be described later) of the wire housing 50 to be in communication with the wire housing 50.

(Wire Housing 50)

The wire housing 50 is a recess in the cross sectional view, and the recess is defined by: a pair of groove walls 52 extending in the direction in which the batteries 11 are juxtaposed; and a bottom wall 53 connecting the paired groove walls 52 together. By jointing the holder units 31 together, the wire housings 50 are coupled together to be in communication with each other, such that a single groove (wire housing groove 51) is formed to extend in the direction in which the batteries 11 are juxtaposed.

Each detecting wire W taken out from the guiding groove 45 of each holder unit 31 is bent at substantially a right angle, and housed in the wire housing 50 along the extending direction of the wire housing 50. The plurality of detecting wires W housed in the wire housing 50 is guided to a battery ECU.

In respect of the paired groove walls 52, the groove wall located closer to the guiding groove 45 will be referred to as a rear groove wall 52A while the other groove wall will be referred to as a front groove wall 52B. The rear groove wall 52A is provided with the opening 52C dividing the rear groove wall 52A into two portions. The guiding groove 45 penetrates through the opening 52C. From the front groove wall 52B, the second lid 55 that covers the wire housing 50 is continuously formed via a hinge 54.

(Second Lid 55)

As depicted in FIGS. 1, 3, 6 and 7, the wire housing 50 is provided integrally with the second lid 55 via the hinge 54 continued from the lateral surface of the front groove wall 52B. The second lid 55 is rotated around the hinge 54. When the second lid 55 is closed, the second lid 55 covers the entire wire housing 50 (see, FIGS. 1 and 3). The lateral edge of the second lid 55 is provided with an extension lid 56 having a pair of second locking pieces 57 that locks the second lid 55. When the second lid 55 is closed, the extension lid 56 covers the guiding groove 45 from the above. The second locking pieces 57 protrude from both widthwise lateral edges of the extension lid 56. The second locking pieces 57 are locked by the second locking grooves 47 formed at both widthwise sides of the guiding groove 45.

In this embodiment, when the first lid 41 is closed after the closure of the second lid 55, a part of the extension lid 56 of the second lid 55 and a part of the first lid 41 are layered upon each other, such that the guiding groove 45 is doubly covered with the extension lid 56 of the second lid 55 as well as the first lid 41. With this configuration, the entire upper region of the holder unit 31 is kept covered with the lids 41 and 55.

(Coupling Structure of Holder Units 31)

In the next description, the coupling structure for use in coupling the neighboring holder units 31 together will be described.

As depicted in FIGS. 4 and 6, the holder unit 31 includes: a joint engaging nail 48 configured to be engaged with the neighboring holder unit 31; and a joint engaging recess 49 engageable with the joint engaging nail 48, and the joint engaging nail 48 and the joint engaging recess 49 are positioned adjacently to the paired first locking grooves 46 of the holder unit 31. The joint engaging nail 48 is positioned to the right (front side in the insertion direction of the bus bar 21) of the first locking groove 46 located on the right side in the depiction while the joint engaging recess 49 is positioned to the left of the first locking groove 46 located on the left side in the depiction.

When a pair of elastic pieces 48A included in the joint engaging nail 48 of the holder unit 31 is inserted into the joint engaging recess 49 of the holder unit 31 that neighbors the former holder unit 31, the joint engaging nail 48 is elastically deformed in a direction in which the paired elastic pieces 48A approach each other, to be inserted into the joint engaging recess 49. When the joint engaging nail 48 reaches a predetermined position within the joint engaging recess 49, the elastic pieces 48A elastically return to their original positions, thereby engaging with the joint engaging recess 49.

Further, as depicted in FIGS. 4 and 6, the first lid 41 includes the lid joints 43 and 44 for use in jointing the first lids 41 of the neighboring holder units 31. The lid joints 43 and 44 are positioned at both sides of the paired first locking pieces 42 of the first lid 41. The right end of the first lid 41 (as depicted in FIG. 4) is provided with the lid joint engaging piece 43 while the left end of the first lid 41 (as depicted in FIG. 4) is provided with the lid joint engaged portion 44.

The end of the lid joint engaging piece 43 includes a joint engaging projection 43A that engages a joint engaged hole 44B of the lid joint engaged portion 44 paired with the lid joint engaging piece 43. The lid joint engaged portion 44 includes: an engaging piece insertion portion 44A that accepts the insertion of the lid joint engaging piece 43 and penetrates in the direction in which the holder units 31 are jointed; and the joint engaged hole 44B that is provided adjacently to the engaging piece insertion portion 44A and accepts the joint engaging projection 43A of the lid joint engaging piece 43 for the engagement therewith. By inserting the lid joint engaging piece 43 into the engaging piece insertion portion 44A of the lid joint engaged portion 44, the joint engaging projection 43A is engaged with the joint engaged hole 44B. In this manner, the neighboring first lids 41 are jointed together.

(Method of Attaching the Battery Wiring Module 20)

Next, the method of attaching the battery wiring module 20 will be described.

First of all, the bus bars 21 are attached to the holder units 31. By inserting the bus bar 21 into the holding portion 32 through the open end 34 of the holding portion 32 of the holder unit 31, the bus bar 21 is guided to the right side in FIG. 4 by the guide 36 provided to the rear wall 33A of the holding portion 32. When the expanded portion 22A of the bus bar 21 abuts on the bus bar locking nail 39D provided to the front wall 33B, the bus bar locking nail 39D is deformed to be bent outward of the encompassing wall 33.

When the bus bar 21 is further inserted frontward (in the right direction in FIG. 4) and the recess 24 of the bus bar 21 reaches the bus bar locking nail 39D, the bus bar locking nail 39D is accepted into the recess 24 of the bus bar 21, and the bus bar locking nail 39D elastically returns to the original position. With the end surface of the expanded portion 22A of the bus bar 21 abutting on the bus bar locking nail 39D, the front and back movement of the bus bar 21 in the insertion direction is restricted. In addition, the bus bar 21 is restricted by the locking portions 35 provided to the encompassing wall 33 from moving in the up and down direction, and locked thereto.

Subsequently, the neighboring holder units 31 are coupled together. When the paired elastic pieces 48A of the joint engaging nail 48 of the holder unit 31 are inserted in the joint engaging recess 49 of the neighboring holder unit 31 with the first lid 41 and the second lid 55 open, the paired elastic pieces 48A are elastically deformed in a direction in which the paired elastic pieces 48A approach each other to be inserted thereinto. Then, the elastic pieces 48A reach the predetermined position in the joint engaging recess 49, the elastic pieces 48A elastically return to their original positions, and engaged with the joint engaging recess 49. In this manner, the holding portion 32 is coupled with the wire housing 50.

Further, after the lid joint engaging piece 43 is inserted into the engaging piece insertion portion 44A of the lid joint engaged portion 44 of the neighboring holder unit 31, the joint engaging projection 43A is engaged with the joint engaging hole 44B. By this operation, the neighboring first lids 41 are coupled together. By coupling together the plurality of holder units 31 holding the bus bars 21, the insulating wall 33C of the holder unit 31 is positioned between the neighboring bus bars 21. Even when the holding portion 32 is provided with the open end 34, the bus bars 21 do not contact each other.

Next, the voltage detecting terminal 25 is fitted to the bus bar 21 housed in the holding portion 32 from the above, and the detecting wire W crimped to the voltage detecting terminal 25 is taken out from the guiding groove 45, and guided to the wire housing 50 (the wire housing groove 51). In this manner, the voltage detecting terminal 25 is attached. When the voltage detecting terminal 25 is attached to the holding portion 32, first of all, the second protruding piece 28B of the voltage detecting terminal 25 is inserted under the terminal locking piece 37. Then, the second protruding piece 28B of the voltage detecting terminal 25 is restricted by the locking protrusion 38 of the terminal locking piece 37 from moving upward and from moving frontward and rearward in the insertion direction of the bus bar 21, and positioned thereto.

The end edge of the terminal detecting terminal 25 closer to the barrel 25B is pressed from the above to the holding portion 32. Then, the voltage detecting terminal 25 abuts on the terminal locking nail 39C of the elastic engaging piece 39A, and the terminal locking nail 39C is deformed to be bent outward of the encompassing wall 33. When the voltage detecting terminal 25 is further pressed downward and the voltage detecting terminal 25 is positioned to be lower than the lower end of the terminal locking nail 39C, the terminal locking nail 39C elastically returns to the original position, and extends over the voltage detecting terminal 25, thereby restricting the up and down movement of the voltage detecting terminal 25.

When the attachment of all of the voltage detecting terminals 25 is over, the battery wiring module 20 is completed.

Next, the battery wiring module 20 is attached to the battery group 10. The battery group 10 is prepared by juxtaposing the batteries 11 such that the neighboring electrode terminals 12 of the neighboring batteries 11 exhibit different polarities. Then, the battery wiring module 20 is attached to the battery group 10. More specifically, the electrode terminals 12 (the electrode posts 13B) of the batteries 11 are inserted into the through holes 23 of the bus bars 21 and the insertion holes 27 of the voltage detecting terminals 25 layered on the through holes 23.

At this time, according to the battery wiring module 20 of this embodiment, the bus bars 21 are inserted in the direction in which the batteries 11 are juxtaposed, and the bus bars 21 are held by the locking portions 35 with its up and down movement restricted with respect to the holding portion 32. Therefore, even when the electrode post 13B or the upper surface 11A (terminal forming surface) of the batteries 11 collide with the resin protector 30, the bus bars 21 are not easily pushed upward, and thus the operations are smoothly conducted.

The electrode posts 13B are inserted into the through holes 23 or the through holes 23 and the insertion holes 27, such that the bus bars 21 are positioned to contact the bases 13A of the electrode terminals 12. Then, by screwing (not depicted) the electrode posts 13B thereto, the electrode posts 13B are fixed thereto. At this time, since the encompassing walls 33 of the holder units 31 are sized to be higher than the electrode posts 13B, short circuits will not be generated even when the tools for use in screwing the electrode posts 13B are dropped thereto or brought into contact therewith. When the fixation of the electrode posts 13B by screwing is completed by repeating the above operations, the battery group 10 becomes electrically connectable. Subsequently, the second lid 55 and the first lid 41 of the battery wiring module 20 are closed in this order, and the battery module M is completed.

(Operations and Advantageous Effects of the Present Embodiment)

In the following description, the advantageous effects of this embodiment will be described.

In this embodiment, the resin protector 30 is provided with the bus bar insertion portion 34 (open end 34) with which the bus bars 21 are inserted in the direction in which the plural batteries 11 are juxtaposed. The bus bars 21 are inserted in the direction in which the batteries 11 are juxtaposed, and the bus bars 21 are held by the locking portion 35 with the up and down direction restricted with respect to the holding portion 32. Accordingly, even when the upper surfaces 11A (terminal forming surface) or the electrode terminals 12 of the batteries 11 collide with the resin protector 30, the bus bars 21 are restricted by the locking portion 35 from the above, and not easily pushed upward. Thus, the configuration prevents the bus bars 21 from disengaging therefrom at the time of attaching the battery wiring module 20 to the battery group 10. As a result, this embodiment provides the battery wiring module 20 efficiently attachable to the battery group 10.

Particularly, according to this embodiment, the holding portion 32 is provided with the guide 36 that guides the bus bar 21 to the front side in the insertion direction of the bus bar 21, and thus the bus bar 21 is smoothly inserted, thereby enhancing the operability.

Further according to this embodiment, the resin protector 30 includes the plurality of holder units 31 each having the holding portion 32 and the bus bar insertion portion 34. By preparing the holder units 31 in which the bus bars 21 are held by the holding portions 32 after having been inserted through the bus bar insertion portion 34 in the juxtaposition direction of the batteries 11, such that the number of the holder units 31 corresponds to the number of the batteries 11, the battery wiring module 20 is attached to a variety of battery groups 10.

Further according to this embodiment, the front end (i.e., the end located frontward in the insertion direction of the bus bars 21) of the holding portion 32 of the holder unit 31 is provided with the insulating wall 33C that keeps the bus bar 21 insulated from the bus bar 21 disposed on the neighboring holder unit 31. With the insulating wall 33C, the bus bars 21 held by the neighboring holder units 31 are kept insulated.

Particularly, according to this embodiment, while the holding portion 32 is provided with the bus bar locking nail 39D that locks the bus bar 21, the bus bar 21 is provided with a locked portion to be locked by the bus bar locking nail 39D. Thus, the disengagement of the bus bar 21 from the holding portion 32 is more reliably prevented.

Further according to this embodiment, the edge (the rear wall 33A) of the holding portion 32 disposed to extend in the direction in which the plural batteries 11 are juxtaposed serves as a holding wall 33A that holds the bus bar 21 without exposing the bus bar 21 therefrom. Therefore, according to this embodiment, the bus bars 21 are not exposed from the edge (the rear wall 33A) of the holding portion 32 disposed to extend in the direction in which the batteries 11 are juxtaposed, and the insulation between the bus bars 21 and the conductive members disposed in the neighborhood of the holding portion 32 are maintained.

### Other Embodiments

The invention is not limited to the embodiments described above and depicted in the drawings, but includes in its technical scope, for instance, the following embodiments.

(1) In the above embodiment, a part of the holding portion 32 is formed to be the open end 34, and serves as the bus bar insertion portion 34 through which the bus bars 21 are inserted in the direction in which the batteries 11 are juxtaposed, but a bus bar insertion inlet provided to a wall portion, through which the bus bars are inserted, may serve as the bus bar insertion portion.

(2) In the above embodiment, in respect of the encompassing wall 33 of the holding portion 32 of the holder unit 31, the right wall 33C disposed at the front end in the insertion direction of the bus bar serves as the insulating wall 33c, but the insulating wall may be prepared separately from the holder unit, or alternatively, the insulating wall may not be provided.

(3) In the above embodiment, the holding portion 32 includes the plurality of locking portions 35 that locks the bus bars 21 to the holding portion 32, but a single locking portion may be provided, or the holding portion may not include any locking portion.

(4) In the above embodiment, the holding portion 32 is provided with the bus bar locking nail 39D that locks the bus bar 21 and the bus bar 21 is provided with the locked portion (the recess 24) locked by the bus bar locking nail 39D, but the holding portion may be provided with a recess bus bar locking portion and the bus bar may be provided with a protruding locked portion.

(5) In the above embodiment, the holding portion 32 is provided with the guide 36 that guides the bus bar 21 from the bus bar insertion portion 34 frontward in the insertion direction of the bus bar 21, but the holding portion may not include any guide.

(6) In the above embodiment, the holding portion 32 has the holding wall that holds the bus bar without exposing therefrom at the edge disposed to extend in the direction in which the plural batteries 11 are juxtaposed, but the holding wall may be provided separately from the holding portion.

### EXPLANATION OF SYMBOLS

M: Battery module
10: Battery group
11: Battery
11A: Upper surface (terminal forming surface)
12: Electrode terminal
12A: Positive electrode terminal
12B: Negative electrode terminal
20: Battery wiring module
21: Bus bar (connector)
22A: Expanded portion (locked portion)
24: Recess
30: Resin protector
31: Holder unit
32: Holding portion
33: Encompassing wall
33A: Rear wall (holding wall)
33B: Front wall
33C: Right wall (insulating wall)
34: Open end (connector insertion portion)
35: Locking portion
36: Guide

1-7. (canceled)

8. A battery wiring module attached to a battery group formed by juxtaposing a plurality of batteries each having positive and negative electrode terminals, the battery wiring module comprising:
a plurality of connectors connected to the electrode terminals; and
a resin protector made of an insulating resin and having a holding portion holding the connectors, wherein
the holding portion of the resin protector is provided with a connector insertion portion adapted to insert the connectors in a direction in which the plurality of batteries is juxtaposed.

9. The battery wiring module according to claim 8, wherein the resin protector includes a plurality of holder units each having the holding portion and the connector insertion portion.

10. The battery wiring module according to claim 9, wherein a front end of the holding portion of the holder unit is provided with an insulating wall that keeps the connector insulated from a connector of a neighboring holder unit, the front end being an end located frontward in a direction in which the connectors are inserted.

11. The battery wiring module according to claim 10, wherein the holding portion is provided with a locking portion that locks the connectors to the holding portion.

12. The battery wiring module according to claim 8, wherein the holding portion is provided with a locking portion that locks the connectors to the holding portion.

13. The battery wiring module according to claim 8, wherein:
the holding portion is provided with a locking portion that locks the connectors; and
the connectors are provided with locked portions to be locked by the locking portion provided to the holding portion.

14. The battery wiring module according to claim 8, wherein the holding portion is provided with a guide guiding the connectors from the connector insertion portion frontward in the direction in which the connectors are inserted.

15. The battery wiring module according to claim 8, wherein an edge of the holding portion disposed to extend in the direction in which the batteries are juxtaposed is provided with a holding wall that holds the connectors without exposing the connectors from the holding portion.
